(19) United States
(12) Patent Application Publication
(10) Pub. No.: US 2014/0355665 A1
(43) Pub. Date: Dec. 4, 2014

(54) Adaptive Video Reference Frame Compression with Control Elements

(71) Applicant: Altera Corporation, San Jose, CA (US)

(72) Inventor: ALBERT W. WEGENER, APTOS HILLS, CA (US)

(73) Assignee: Altera Corporation, San Jose, CA (US)

(21) Appl. No.: 13/907,712

(22) Filed: May 31, 2013

(51) Int. Cl. H04N 19/105

(52) U.S. Cl. CPC H04N 19/00024
USPC 375/240.02

(57) ABSTRACT

An access encoder reduces power consumption during video playback and recording by reducing the bandwidth between a processor and a memory. A graphical user interface allows user selection, or software control, over the tradeoff between battery life and video quality. Battery life can be increased (decreased) by activating the access encoder. The access encoder may be implemented in a microprocessor, graphics processor, digital signal processor, FPGA, ASIC, or SoC. The access encoder's encoding/decoding can reduce memory and storage bottlenecks, processor access time, and processor and memory power consumption. A user interface allows users to adjust the tradeoff between decoded video quality and battery life for a mobile device. This abstract does not limit the scope of the invention as described in the claims.

### BACKGROUND

The technology described herein encodes pixel data of video frames using reference frame compression options that apply lossless, fixed-rate, fixed-quality, or a hybrid fixed-rate/fixed-quality mode to individual macroblocks in reference frames, under user and/or feedback control. In imaging applications, it is often desirable to capture, to process, to display, and to store video in mobile, portable, and stationary devices. The prodigious number of pixels captured during video processing can create capacity and bandwidth bottlenecks in such devices, which increase power consumption and decrease battery life of the mobile device. In video applications using mobile processors (smart phones and tablets), low-complexity encoding and decoding techniques that minimize power consumption and maximize battery life are preferred. It would be beneficial to allow users of battery-powered devices, including mobile devices, to control the tradeoff between video quality (during either video playback or video recording, or both) and battery life.

Standard video compression algorithms such as JPEG2000, MPEG2 and H.264 reduce image and video bandwidth and storage bottlenecks at the cost of additional computations and reference frame storage (previously decoded image frames). In video applications, if lossless or lossy compression of macroblocks within reference frames were used to reduce memory capacity requirements and to reduce memory access time, it would be desirable that such macroblock encoding be computationally efficient in order to minimize demands on computing resources. It would be further desirable that the macroblock encoding method support multiple methods that independently or jointly offer users multiple modes and settings to optimize the user's desired bit rate vs. image quality tradeoff. Finally, it would be desirable if users could control the tradeoff between battery life and video quality using a convenient control mechanism or graphical user interface.

Video systems are ubiquitous in both consumer and industrial applications using microprocessors, computers, and dedicated integrated circuits called systems-on-chip (SoCs) or application-specific integrated circuits (ASICs). Such video systems can be found in personal computers, laptops, tablets, and smart phones; in televisions, satellite and cable television systems, and set-top boxes (STBs); and in industrial video systems that include one or more cameras and a network for capturing video from monitored systems as diverse as factories, office buildings, and geographical regions (such as when unmanned aerial vehicles or satellites perform reconnaissance). Such video systems typically capture sequential frames of image data from image sensors that support raster-based access. Similarly, video systems typically use monitors or displays on which users view the captured still images or videos. Because digital video systems require memory access to tens or even hundreds of Megabytes (MByte) per second for recording or playback, several generations of video compression standards, including Moving Picture Experts Group (MPEG and MPEG2), ITU H.264 (Advanced Video Codec), and the new H.265 (High Efficiency Video Codec) were developed to reduce memory bandwidth and capacity requirements of video recording and playback. These video processing standards achieve compression ratios between 10:1 and 50:1 by exploiting pixel correlations in image regions between successive frames. Many pixels in the current frame can be identical, or only slightly shifted horizontally and/or vertically, to corresponding pixels in previous frames. The aforementioned image compression standards operate by comparing areas of similarity between subsets (typically called macroblocks, or MacBlks) of the current image frame to equal-sized subsets in one or more previous frames, called “reference frames.” The aforementioned standard video compression algorithms store one or more reference frames in a memory chip (integrated circuit or IC) that is typically separate from the chip (IC) performing the encoding and/or decoding algorithm. The interconnection between these two chips often comprises hundreds of pins and wires that consume considerable power as the video encoding and/or decoding IC reads/writes reference frames from/to the memory IC. Video encoder motion estimation (ME) and video decoder motion compensation (MC) processing accesses uncompressed MacBlks (regions of reference frames) in main memory, also called dynamic random access memory (DRAM) or double data rate (DDR) memory.

Especially in mobile and portable devices, where only a limited amount of power is available due to battery limitations, it is desirable to use as little power for video recording and playback as possible. A significant amount of power, in some instances exceeding 30%, is consumed during video encoding when the ME process accesses MacBlks in reference frames stored in off-chip DDR memory, and during video decoding when the MC process accesses MacBlks in reference frames stored in off-chip DDR memory. In today's portable computers, tablets, and smart phones, the video encoding and decoding process is often orchestrated by one or more cores of a multi-core integrated circuit (IC).

The present specification describes multiple techniques for performing low complexity encoding of MacBlks within reference frames in a user-programmable or software application-controlled way that allows tradeoffs between the resulting bit rate (and corresponding image quality) of the decoded reference frame, and the power consumption required for reference frame processing during ME and MC. As reference frames are written to DDR memory, the present invention encodes them according to a user-selected “battery life vs. video quality” tradeoff. Video quality can be specified using one or more image quality metrics, such as peak signal-to-noise ratio (PSNR), Structural Similarity (SSIM), Pearson's Correlation Coefficient (PCC), or signal-to-noise ratio (SNR). Video compression ratio or bit rate is typically specified numerically, such as 4:1 compression ratio or 5.5 bits per color pixel. The present invention thus allows users to trade off battery life and video quality in a flexible way. An example that illustrates the benefits of the present invention might involve a mobile device user viewing a movie (video) on an airplane. Perhaps the user's movie still has 30 minutes left to view till the end, while the user's device only has 15 minutes of battery life left at the present settings. Such a user might find significant advantage if he or she could summon a control application (“app”) on their device that allowed them to reduce the video quality of their movie so that the battery life could be lengthened while the video quality was reduced. In this manner, this example user would be able to watch the rest of the movie at a reduced (but still acceptable) video quality, to match the device's available battery life.

Mobile video playback devices already face degraded-quality video choices. For example, when a user streams a compressed video across a wireless channel to a mobile device, channel conditions can vary depending on the distance between the transmitter and the receiver, or on the channel quality as it is affected by blocking objects, such as buildings, furniture, human beings, or other interfering electronic devices. In such conditions, the mobile device may experience dropped packets of the compressed video stream and must compensate for the missing information (frame of video or partial frame of video) by repeating part or all of a previous frame, averaging parts of previous frames, or other accommodation. Thus present-day (prior art) mobile devices already try to maximize video quality in the presence of adverse channel conditions. Thus users are already aware that certain channel conditions can reduce the video quality of their viewing and/or recording experience.

Commonly owned patents and applications describe a variety of attenuation-based compression techniques applicable to fixed-point, or integer, representations of numerical data or signal samples. These include U.S. Pat. No. 5,839,100 (the '100 patent), entitled “Lossless and loss-limited Compression of Sampled Data Signals” by Wegener, issued Nov. 17, 1998. The commonly owned U.S. Pat. No. 7,009,533, (the '533 patent) entitled “Adaptive Compression and Decompression of Bandlimited Signals,” by Wegener, issued Mar. 7, 2006, incorporated herein by reference, describes compression algorithms that are configurable based on the signal data characteristic and measurement of pertinent signal characteristics for compression. The commonly owned U.S. Pat. No. 8,301,803 (the '803 patent), entitled “Block Floating-point Compression of Signal Data,” by Wegener, issued Apr. 28, 2011, incorporated herein by reference, describes a block-floating-point encoder and decoder for integer samples. The commonly owned U.S. patent application Ser. No. 13/534,330 (the '330 application), filed Jun. 27, 2012, entitled “Computationally Efficient Compression of Floating-Point Data,” by Wegener, incorporated herein by reference, describes algorithms for direct compression floating-point data by processing the exponent values and the mantissa values of the floating-point format. The commonly owned patent application Ser. No. 13/617,061 (the '061 application), filed Sep. 14, 2012, entitled “Conversion and Compression of Floating-Point and Integer Data,” by Wegener, incorporated herein by reference, describes algorithms for converting floating-point data to integer data and compression of the integer data. The commonly owned patent application Ser. No. 13/617,205 (the '205 application), filed Sep. 14, 2012, entitled “Data Compression for Direct Memory Access Transfers,” by Wegener, incorporated herein by reference, describes providing compression for direct memory access (DMA) transfers of data and parameters for compression via a DMA descriptor. The commonly owned patent application Ser. No. 13/616,898 (the '898 application), filed Sep. 14, 2012, entitled “Processing System and Method Including Data Compression API,” by Wegener, incorporated herein by reference, describes an application programming interface (API), including operations and parameters for the operations, which provides for data compression and decompression in conjunction with processes for moving data between memory elements of a memory system.

The commonly owned patent application Ser. No. 13/358,511 (the '511 application), filed Jan. 12, 2012, entitled “Raw Format Image Data Processing,” by Wegener, incorporated herein by reference, describes encoding of image sensor rasters during image capture, and the subsequent use of encoded rasters during image compression using a standard image compression algorithm such as JPEG or JPEG2000.

In order to better accommodate tradeoffs between video quality and battery life during video capture, processing, and display, a need exists for a compression/decompression controller with multiple options that allows users or software programs to control this tradeoff.

### SUMMARY

In one embodiment, a user interface comprises a compression/decompression controller, typically in a graphical user interface or control application, that allows user selection of increasingly lower video quality for increasingly longer battery life. In a second embodiment, the video quality is reduced or improved by the selection of a lower or higher reference frame bit rate. In a third embodiment, the video quality is affected by the specification of a desired video quality, such as PSNR, SNR, SSIM, or PCC. In a fourth embodiment, the video quality is determined for each MacBlk by monitoring the magnitude of motion vectors in the reference frame, where (optionally) high-motion MacBlks are preserved at a higher quality than low-motion MacBlks. The control of video quality, video reference frame processing, and battery life during reference frame encoding and decoding described herein may be implemented using a field-programmable gate array (FPGA), application-specific integrated circuit (ASIC), system-on-chip (SoC), or as an intellectual property (IP) block for an ASIC or SoC. Other aspects and advantages of the present invention can be seen on review of the drawings, the detailed description and the claims, which follow.

### BRIEF DESCRIPTION OF THE DRAWINGS

FIG. 1 is a block diagram of a computing system that captures, processes, stores and displays digital image data, including an access encoder and decoder, in accordance with a preferred embodiment.

FIG. 2 illustrates the organization of an example of a 1080p image frame having 1080 rows (rasters) and 1920 pixels per row (raster) and how macroblocks of 16×16 pixels ore overlaid on the image data.

FIG. 3 illustrates several examples of packing pixel data into a packet.

FIG. 4 illustrates an example of an attenuator-based access encoder.

FIG. 5 illustrates an example of an attenuator-based access decoder.

FIG. 6 illustrates an example of an access encoder using multiple quality metrics in a constant quality control module that are generated using the decompressed reference frames, the input reference frames, and/or the difference between the input and the decompressed reference frames.

FIGS. 7A, 7B (collectively “FIG. 7” herein) illustrate examples of macroblock-based video encoding and decoding algorithms, such as MPEG2, H.264, and H.265 (HEVC) that use one or more reference frames stored in a memory for encoding a current frame of pixels.

FIGS. 8A, 8B (collectively “FIG. 8” herein) illustrate an example of an improved video encoder and decoder using access encoders and access decoders.

FIG. 9 illustrates a graphical user interface that allows user specification of the tradeoff between battery life and video quality.

FIG. 10 illustrates a graphical user interface that allows user specification of which video playback applications are affected by video power savings settings.

FIG. 11 illustrates a graphical user interface that allows user specification of which video record applications are affected by video power savings settings.

FIGS. 12A, 12B (collectively “FIG. 12” herein) illustrate a video encoding parameter called Group of Pictures (GOP) that is typically set during video encoding.

FIG. 13 illustrates how an access encoder's mode and parameter settings implement a flexible “battery life vs. video quality” selection by a user, or by control software.

FIG. 14 illustrates multiple options in which an access encoder's mode and parameter(s) may differ for I-frames and P-frames.

FIG. 15 illustrates the ordering of macroblocks by raster showing macroblocks having different encoding options including lossless, fixed-rate, and fixed-quality.

FIG. 16 illustrates an option whereby the present invention's compression mode is selected on a MacBlk-by-MacBlk basis under the influence of motion vector magnitude.

FIG. 17 illustrates the frame-by-frame image quality of an original video and five alternative videos using five different mode and parameter settings applied to a access encoder and decoder.

FIGS. 18A, 18B (collectively “FIG. 18” herein) illustrate how mobile device power consumption changes as a user trades off longer battery life versus video quality during video playback and recording.

FIG. 19 illustrates nine examples of how power savings changes with three examples of memory power consumption values and three examples compression ratios.

### DETAILED DESCRIPTION

Embodiments of compression/decompression controllers supporting a tradeoff between video quality and battery life described herein may encompass a variety of computing architectures. Video data may include integer data of various bit widths, such as 8 bits, 10 bits, 16 bits, etc. and one or more color planes, such as grayscale (one color plane), RGB (three color planes), or RGBA (four color planes). The video data may be generated by a variety of applications and the computing architectures may be general purpose or specialized for particular applications. For example, the numerical data may arise from image sensor signals that are converted by an analog to digital converter (ADC) in an image sensor to digital form, where the digital samples are typically represented in an integer format. Common color representations of image pixels include RGB (Red, Green, Blue) and YUV (brightness/chroma1/chroma2). Image data may be captured and/or stored in a planar format (e.g. for RGB, all R components, followed by all G components, followed by all B components) or in interleaved format (e.g. a sequence of {R,G,B} triplets).

An image frame has horizontal and vertical dimensions H_DIM and V_DIM, respectively, as well as a number of color planes N_COLORS (typically 3 [RGB or YUV] or 4 [RGBA or YUVA], including an alpha channel). H_DIM can vary between 240 and 2160, while V_DIM can vary between 320 and 3840, with typical H_DIM and V_DIM values of 1080 and 1920, respectively, for a 1080p image or video frame. A single 1080p frame requires at least 1080×1920×3 Bytes=6 MByte of storage, when each color component is stored using 8 bits (a Byte). Video frame rates typically vary between 10 and 120 frames per second, with a typical frame rate of 30 frames per second (fps). As of 2013, industry standard video compression algorithms called H.264 and H.265 achieve compression ratios between 10:1 and 50:1 by exploiting the correlation between pixels in MacBlks of successive frames, or between MacBlks of the same frame. The compression or decompression processing by industry-standard codecs require storage of the last N frames prior to the frame that is currently being processed. These prior frames are stored in off-chip memory and are called reference frames. The present invention's control over video quality and battery life described below influences access to the reference frames between a processor and off-chip memory to reduce the required bandwidth and capacity for MacBlks in reference frame. Reducing (increasing) the bandwidth required for ME and MC increases (reduces) battery life.

Many of the functional units described in the specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical of logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

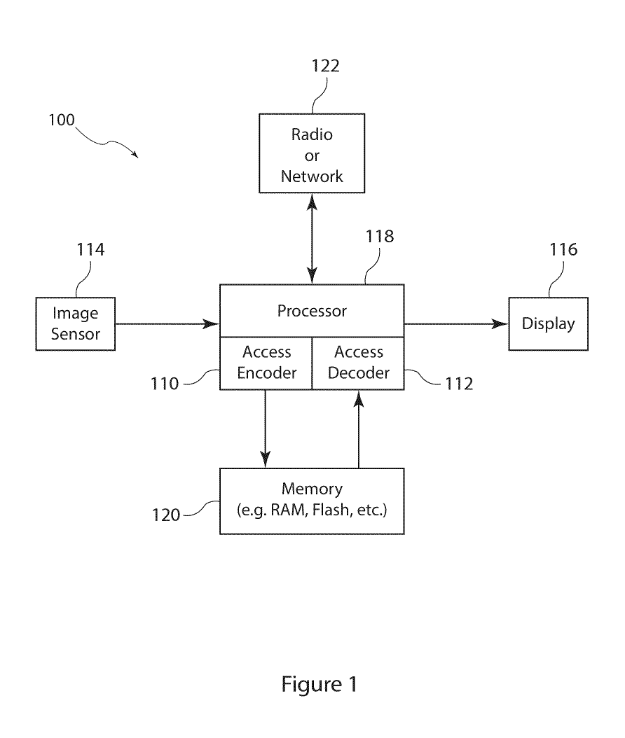

FIG. 1 is a block diagram of a computing system 100 that captures, processes, stores, and displays digital image data, including an access encoder 110 and access decoder 112, in accordance with a preferred embodiment. An image sensor 114 provides pixels to a processor 118, typically raster by raster, for each captured image frame. A display 116 or monitor receives pixels from a processor, typically raster by raster, for each image frame to be displayed. The processor 118 responds to user inputs (not shown) and orchestrates the capture, processing, storage, and display of image data. A memory 120 is used to store reference frame and other intermediate data and meta-data (such as date and time of capture, color format, etc.) and may optionally also be used to store a frame buffer of image data just prior to image display, or just after image capture. An optional radio or network interface 122 allows the processor 118 to transmit or to receive other image data in any format from other sources such as the Internet, using wired or wireless technology. The access encoder 110 encodes the image data for storage in the memory 120 and generates supplemental information for the encoded image data. The image data to be encoded may be in raster format such as when received by the image sensor 114, or in macroblock format, such as unencoded video frame data. The access encoder 110 generates supplemental information for the encoded image data. The processor 118 may use the supplemental information to access the encoded image data in raster format or in macroblock format, as needed for the application processing. The access decoder 112 decodes the encoded image data and provides the decoded image data in raster or macroblock format. The access decoder 112 may provide the decoded image data in raster format, as needed for display, or in macroblock format, as needed for macroblock-based video encoding operations.

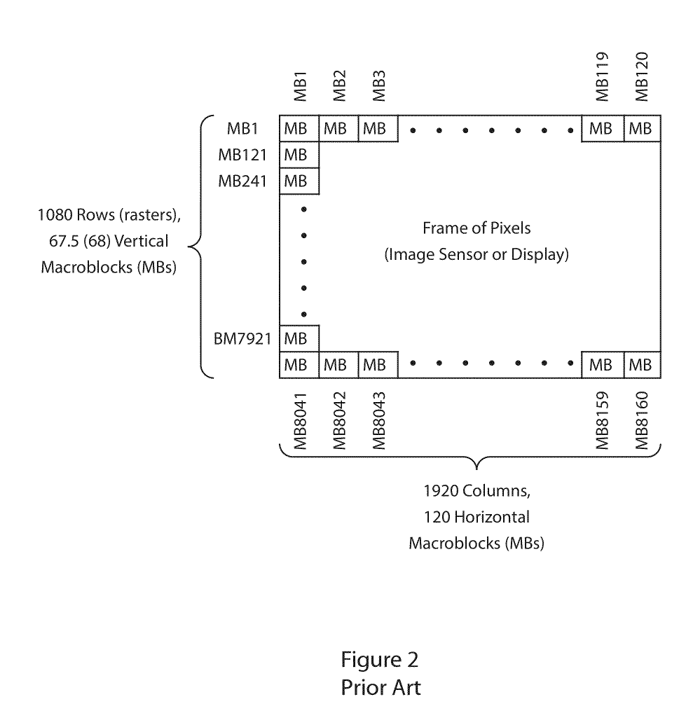

FIG. 2 illustrates the organization of an example of a 1080p image frame having 1080 rows (rasters) and 1920 pixels per row (raster). FIG. 2 also shows how macroblocks of 16×16 pixels are overlaid on the image data, creating 120 horizontal MacBlks (per 16 vertical rasters) and 68 vertical MacBlks (per 16 horizontal rasters), for a total of 8,160 MacBlks per 1080p frame.

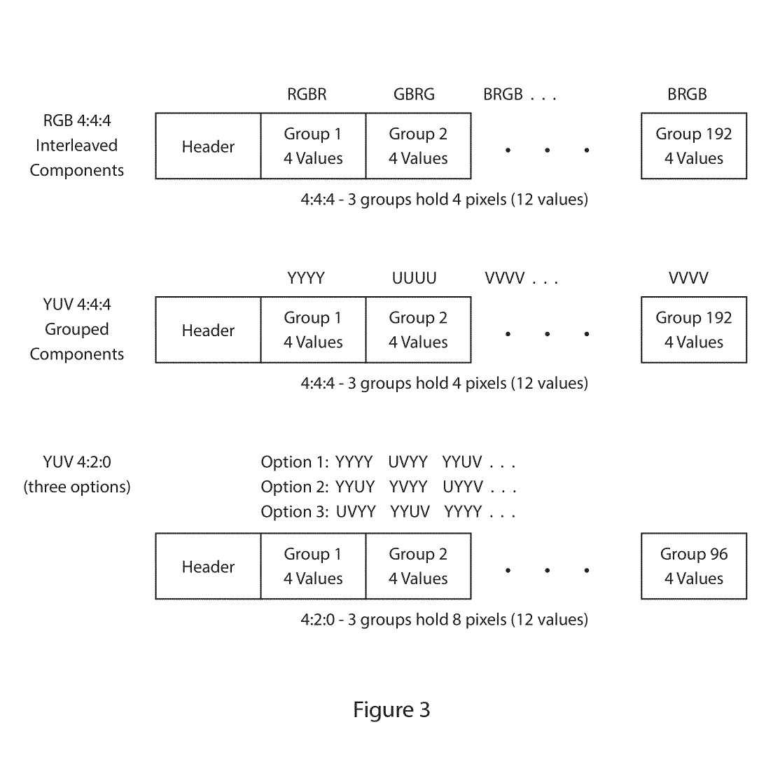

FIG. 3 illustrates several examples of packing pixel data into a packet. The access encoder 110 may apply the techniques described in the '511 application and the '803 application. The '511 application describes algorithms for compressing and storing image data. The '803 patent describes block floating point encoding, that compresses and groups four mantissas (differences) at a time. The access encoder 110 may compress the image data by computing first or second order differences (derivatives) between sequences of samples of the same color components, as described in the '511 application. The access encoder 110 may apply block floating point encoding to the difference values, as described in the '803 patent. The block floating point encoder groups resulting difference values and finds the maximum exponent value for each group. The number of samples in the encoding groups is preferably four. The maximum exponent corresponds to the place value (base 2) of the maximum sample in the group. The maximum exponent values for a sequence of the groups are encoded by joint exponent encoding. The mantissas in the encoding group are reduced to have the number of bits indicated by the maximum exponent value for the group. The groups may contain different numbers of bits representing the encoded samples. FIG. 3 labels such grouped components “Group 1, Group 2,” etc. The access encoder 110 allows flexible ordering of the groups of compressed color components. In the examples of FIG. 3, three groups of 4 encoded components can store image components in any of the following ways:

a. Example 1, RGB 4:4:4: {RGBR}, {GBRG}, {BRGB}

b. Example 2, YUV 4:4:4: {YYYY}, {UUUU}, {VVVV}

c. Example 3, YUV 4:2:0: {YYYY}, {UVYY}, {YYUV}, Option 1

d. Example 4, YUV 4:2:0: {YYUY}, {YVYY}, {UYYV}, Option 2

e. Example 5, YUV 4:2:0: {UVYY}, {YYUV}, {YYYY}, Option 3

The access encoder 110 may form a packet containing a number of the groups of encoded data for all the color components of the pixels in one macroblock. For RGB 4:4:4 and YUV 4:4:4, the number of groups of encoded data is preferably 192. For YUV 4:2:0, the number of groups is preferably 96. The packets may include a header that contains parameters used by the access decoder 112 for decoding the groups of encoded data.

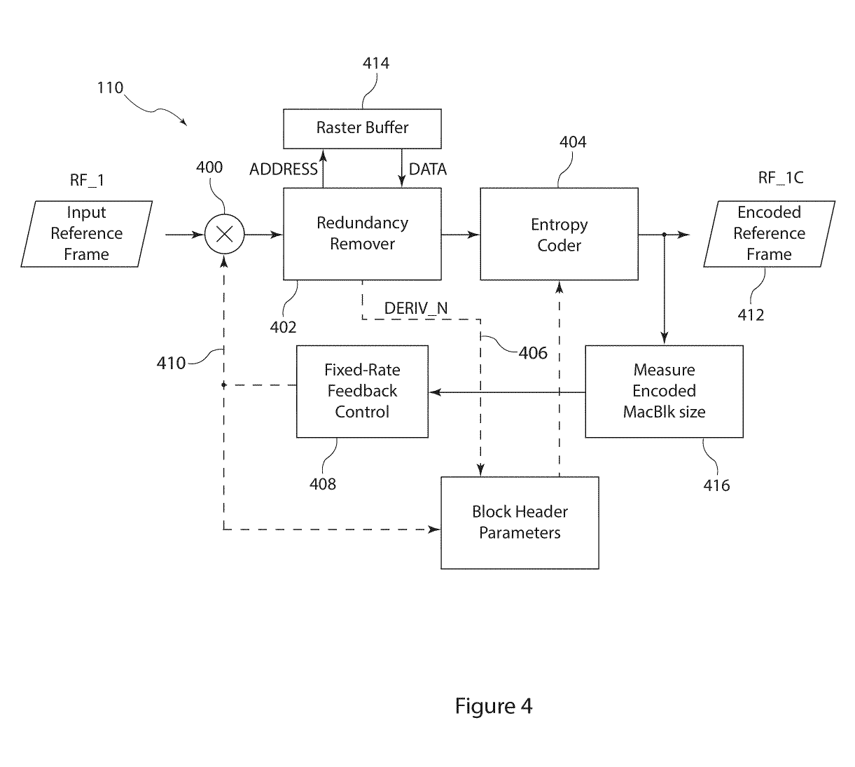

FIG. 4 is a block diagram of the access encoder 110, in accordance with a preferred embodiment. Aspects of these access encoder 110 components are described in the '533 patent, the '205 application, and the '511 application. The access encoder 110 includes an attenuator module 400, a redundancy remover 402, and an entropy coder 404. A preferred embodiment of the entropy encoder 404 comprises a block exponent encoder and joint exponent encoder, as described in the '803 patent. The redundancy remover 402 may store one or more previous rasters (rows of pixels) in a raster buffer 414. The raster buffer 414 enables the redundancy remover 402 to select from among three alternative image component streams:
a. The original image components (such as RGB or YUV),
b. The first difference between corresponding image components, where the variable “i” indicates the current image component along a row or raster, such as:
   1. R(i)-R(i−1), followed by
   2. G(i)-G(i−1), followed by
   3. B(i)-B(i−1); or
   4. Y(i)-Y(i−1), followed by
   5. U(i)-U(i−1), followed by
   6. V(i)-V(i−1)
c. The difference between corresponding image components from the previous row (raster), where the variable i indicates the current image component along a row or raster, and the variable j indicates the current row or raster number, such as:
   1. R(i,j)-R(i,j−1), followed by
   2. G(I,j)-G(i,j−1), followed by
   3. B(i,j)-B(i,j−1); or
   4. Y(i,j)-Y(i,j−1), followed by
   5. U(i,j)-U(i,j−1), followed by
   6. V(i,j)-V(i,j−1).

During the encoding of the current MacBlk, the redundancy remover 402 determines which of these three streams will use the fewest bits, i.e. will compress the most. That stream is selected as the “best derivative” for the next encoded MacBlk. The “best derivative” selection is encoded in the encoded MacBlk's header as indicated by the DERIV_N parameter 406 in FIG. 4. The entropy coder 404 receives the selected derivative samples from the redundancy remover 402 and applies block floating point encoding and joint exponent encoding to the selected derivative samples. The block floating point encoding determines the maximum exponent values of groups of the derivative samples. The maximum exponent value corresponds to the place value (base 2) of the maximum valued sample in the group. Joint exponent encoding is applied to the maximum exponents for a sequence of groups to form exponent tokens. The mantissas of the derivative samples in the group are represented by a reduced number of bits based on the maximum exponent value for the group. The sign extension bits of the mantissas for two's complement representations or leading zeros for sign-magnitude representations are removed to reduce the number of bits to represent the encoded mantissas. The parameters of the encoded MacBlk may be stored in a header. The entropy coder may combine the header with the exponent tokens and encoded mantissa groups to create an encoded MacBlk. To support fixed-rate encoding, in which a user can specify a desired encoding rate, the access encoder 110 includes a block to measure the encoded MacBlk size 416 for each encoded MacBlk. A fixed-rate feedback control block 408 uses the encoded MacBlk size 416 to adjust the attenuator setting (ATTEN) 410. More attenuation (smaller ATTEN value) will reduce the magnitudes of all three candidate streams provided to the redundancy remover 402, and thus will increase the encoding (compression) ratio achieved by the access encoder 110 of FIG. 4. Averaged over several encoded MacBlks, the fixed-rate feedback control may achieve the user-specified encoding rate. The access encoder 110 generates one or more encoded MacBlks. A number of encoded MacBlks comprise encoded reference frame RF_{—}1C 412.

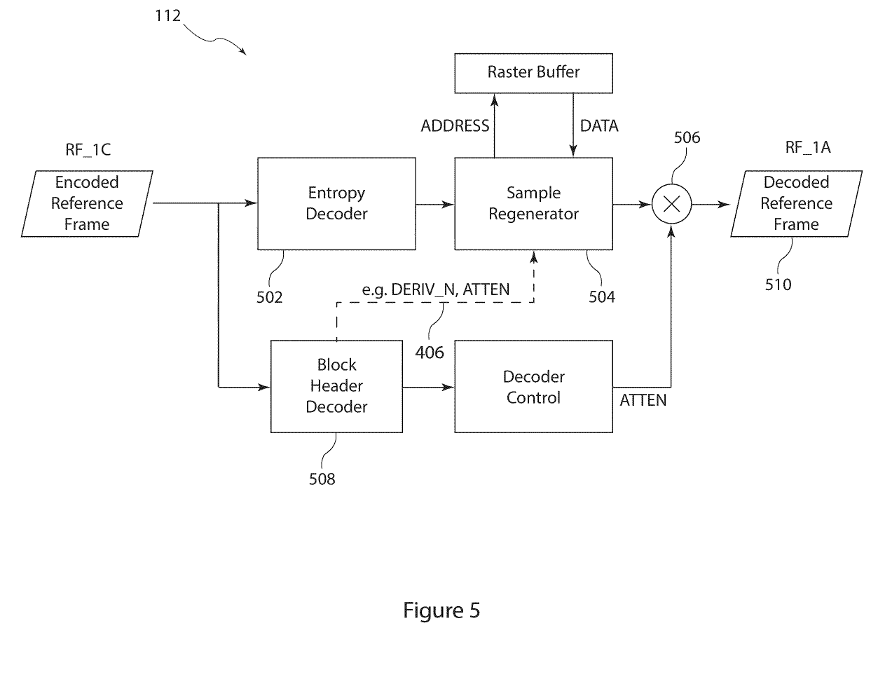

FIG. 5 is a block diagram of an access decoder 112, in accordance with a preferred embodiment. Aspects of these decoder components are described in the '533 patent, the '205 application, and the '511 application. The access decoder 112 preferably includes an entropy decoder 502, a sample regenerator 504, and a gain module (multiplier) 506. The entropy decoder 502 preferably comprises block floating point decoder and joint exponent decoder (JED), further described in the '803 patent. A state machine (not shown in FIG. 5) in the access decoder 112 separates the encoded MacBlks into header and payload sections, and passes the header sections to a block header decoder 508, which decodes MacBlk header parameters such as DERIV_N and ATTEN. The sample regenerator 504 inverts the operations of the redundancy remover 402 in accordance with the parameter DERIV_N provided in the encoded macroblock's header. For example, when the redundancy remover 402 selected original image components the sample regenerator 504 provides decoded image components. For another example, when the redundancy remover 402 selected image component pixel differences or image component raster/row differences, the sample regenerator 504 would integrate, or add, the pixel differences or raster/row differences, respectively, to produce decoded image components. The sample regenerator 504 stores the decoded image components from one or more previous rasters (rows of pixels) in a raster buffer 414. These decoded image components are used when the MacBlks was encoded using the previous row/raster's image components by the access encoder 110, as described with respect to FIG. 4. The inverse of the parameter ATTEN is used by the gain module (multiplier) 506 of FIG. 5 to increase the magnitude of regenerated samples from the sample regenerator block 504. The access decoder 112 generates one or more decoded MacBlks. A number of decoded MacBlks comprise a decoded reference frame RF_{—}1A 510 as shown in FIG. 5. When the access encoder 110 operates in a lossless mode, the decoded MacBlks of RF_{—}1A will be identical to MacBlks of the input reference frame RF_{—}1. When the access encoder 110 operates in a lossy mode, the decoded MacBlks of RF_{—}1A will approximate the MacBlks of the input reference frame RF_{—}1 418. In a preferred embodiment of the lossy mode, the difference between the approximated MacBlks and the original MacBlks is selected or controlled by a user. The larger the encoding ratio the larger the difference between the approximated and original (input) MacBlks, but also the greater the savings in power consumption and the greater the battery life of a mobile device that utilizes the flexible, adaptive, user-controlled access encoder/decoder.

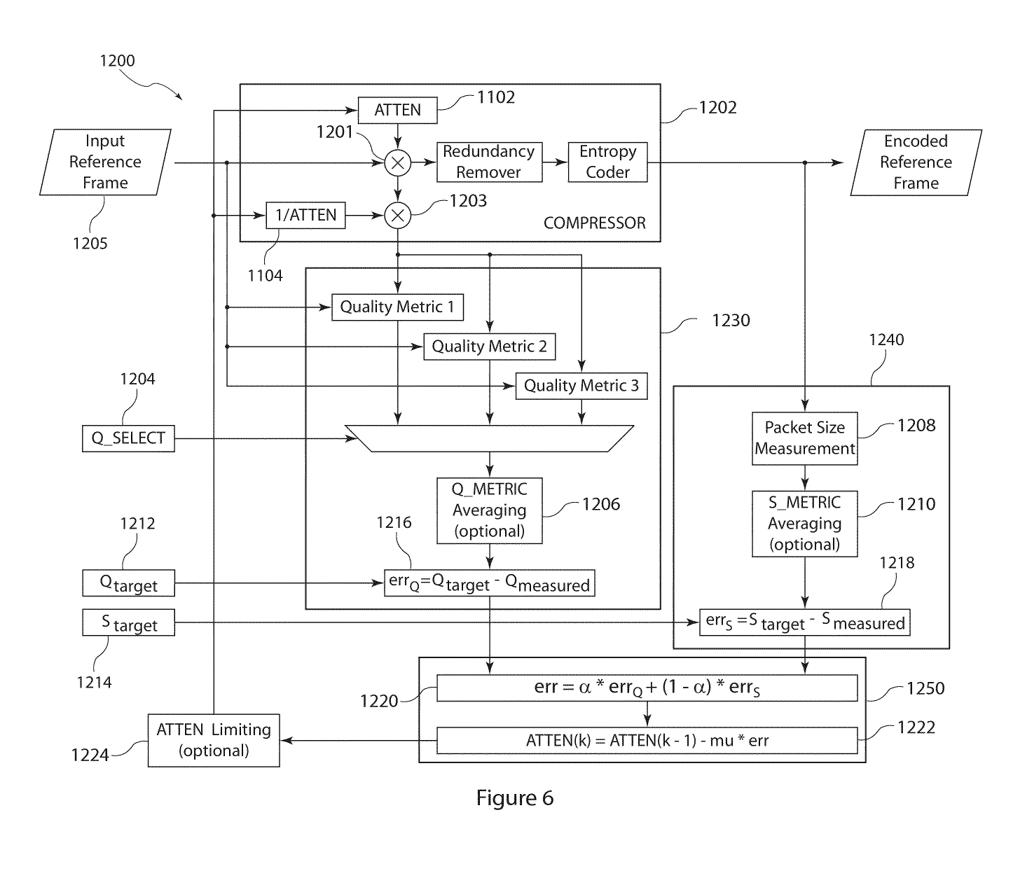

FIG. 6 illustrates an example of an access encoder using three quality metrics in a constant quality control module 1230 that are generated using the decompressed reference frames, the input reference frames 1205, and/or the difference between the input and the decompressed reference frames, in accordance with a preferred embodiment. The Q_SELECT control module 1204 determines which of the quality metrics are used as input to the optional fixed-quality Q_METRIC averaging module 1206. A fixed-rate control module 1240 has a packet size measurement block 1208 that measures packet size S. The packet size measurement is used as an input to an optional S_METRIC averaging block 1210. Averaging the quality and compressed packet size metrics smoothes the instantaneous quality and packet size metrics which leads to smoother feedback loop performance. The averaging method can be simple (“average the last N samples with equal weighting”) or more complex (“apply finite impulse response [FIR] filter coefficients to the previous N measurements, to smooth the quality and/or size metrics”). Given a target quality metric Q_{target} 1212 and a target compressed packet size metric S_{target} 1214, a quality error err_{Q} 1216 and size error err_{S} 1218 can be created.

An attenuation parameter module 1250 calculates an error parameter 1220 which is then used to calculate the hybrid attenuation parameter 1222. The parameter alpha (α) determines how err_{Q} 1216 and err_{S} 1218 parameters are blended (hybridized) to create a hybrid error parameter “err” 1220. Finally, the “err” term 1220 is multiplied by the adaptive feedback rate control parameter mu (μ) to update the ATTEN value 1222 that is subsequently applied to new input samples being compressed. An optional ATTEN_LIMITING block 1224 may restrict the minimum and maximum ATTEN value to ATTEN_MIN and ATTEN_MAX, respectively. FIGS. 4, 5, and 6 are examples of compression control modules.

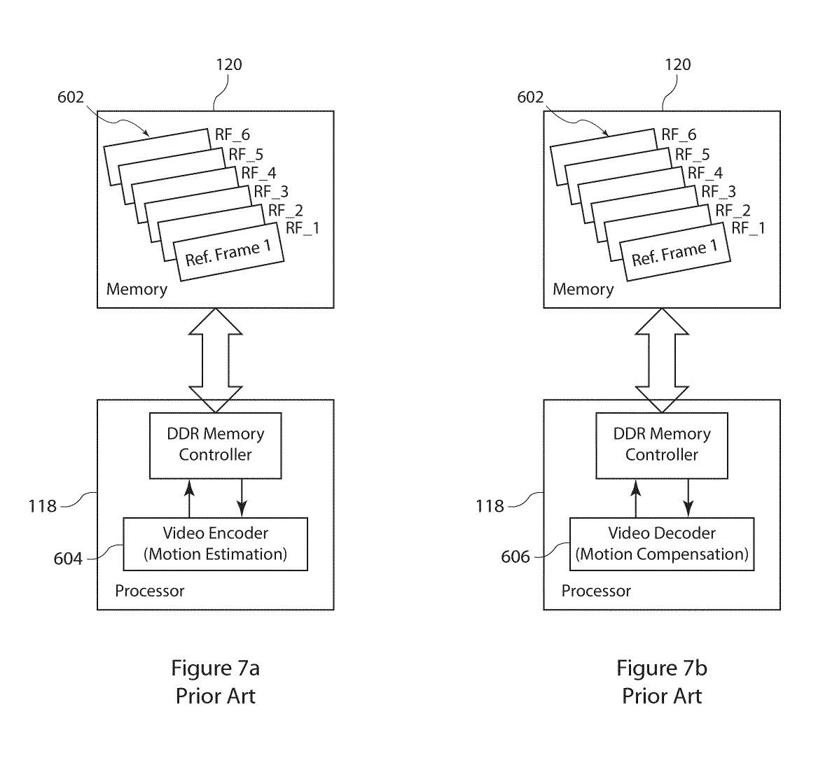

FIGS. 7a and 7b illustrate examples of macroblock-based video encoding and decoding algorithms, such as MPEG2, H.264, and H.265 (HEVC) that use one or more reference frames stored in a memory 120 for encoding a current frame of pixels. The macroblock-based video encoding algorithms have previously encoded the reference frames, decoded the encoded reference frames and stored the previously decoded reference frames RF_{—}1 to RF_{—}6 602 for use in motion estimation calculations for encoding the current frame. FIG. 7a illustrates an example of a video encoder where previously decoded reference frames are stored in a memory 120. For this example, six previously decoded reference frames RF_{—}1 to RF_{—}6 602 are stored in the memory 120 in uncompressed (unencoded) form, in formats such as RGB or YUV 4:2:0. RF_{—}1 is the reference frame immediately preceding the current frame being decoded. The video encoder's processor may access one or more macroblocks in any of the previously decoded reference frames RF_{—}1 thru RF_{—}6 602 during the motion estimation process to identify a similar macroblock to the current macroblock in the frame currently being encoded. A reference frame to that most similar macroblock in the one or more reference frame RF_{—}1 thru RF_{—}6 in this example is then stored in the encoded video stream as a “motion vector.” The motion vector identifies the most similar prior macroblock in the reference frames RF_{—}1 thru RF_{—}6 602, possibly interpolated to the nearest ½ or ¼-pel location. As shown in FIG. 7b, the video decoder stores the same previously decoded reference frames RF_{—}1 thru RF_{—}6 602 during motion compensation as did the video encoder 604 during motion estimation. The video decoder 606 retrieves the macroblock in the previously decoded reference frame corresponding to the motion vector. The video decoder 606 optionally interpolates the most-similar macroblock's pixels by ½ or ¼-pel, as did the video encoder 604. In this manner, both the video encoder 604 shown in FIG. 6a and the video decoder 604 shown in FIG. 6b reference the same reference frames while encoding and decoding a sequence of images of a video.

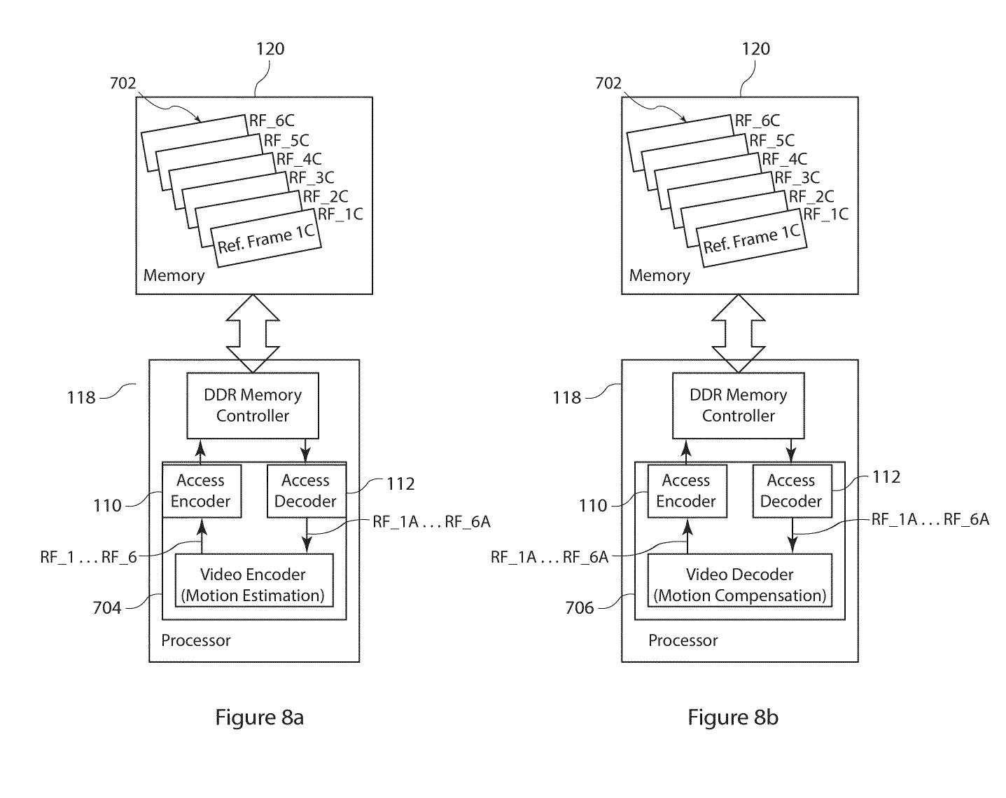

FIGS. 8a and 8b illustrate examples of systems in which a video encoder 704 and a video decoder 706 include an access encoder 110 and an access decoder 112. FIG. 8a illustrates a video encoder system that includes an access encoder 110 and an access decoder 112. The access encoder 110 encodes MacBlks of reference frame to be used by video encoder 704, which stores encoded (compressed) MacBlks. The macroblock-based video encoding algorithms have previously encoded the reference frames, decoded the encoded reference frames and stored the previously decoded reference frames RF_{—}1 to RF_{—}6 702 for use in motion estimation calculations for encoding the current frame. The access decoder 112 retrieves and decodes encoded MacBlks to provide decoded (decompressed) MacBlks from reference frame during the video encoder's 704 Motion Estimation (ME) process.

FIG. 8b illustrates a video decoder system that includes an access encoder 110 and an access decoder 112. The access encoder 110 encodes MacBlks of reference frames to be used by the video decoder 706, which stores the encoded (compressed) MacBlks. The access decoder 112 retrieves and decodes the encoded MacBlks to provide decoded (decompressed) MacBlks from reference frames during the video decoder's 706 Motion Compensation (MC) process. When the settings (lossless/lossy mode setting, and for lossy encoding, the lossy encoding, or compression, rate) of the access encoder/decoder pair are identical in the video encoder 704 (FIG. 7a) and video decoder 706 (FIG. 7b), the decoded MacBlks from approximated reference frames RF_{—}1A thru RF_{—}6A 702 in this example will be identical in both the video encoder 704 (FIG. 7a) and the video decoder 706 (FIG. 7b). Decoded MacBlks in both the video encoder 704 (FIG. 7a) and video decoder 706 (FIG. 7b) will be identical, regardless of the operating mode (lossless or lossy) and the encoding (compression) rate for the lossy mode. Thus, the video encoder system and video decoder system can use the access encoder/decoder in the lossy or lossless mode. These modes and the encoding rate (compression ratio) may be selectable by the user via a user interface.

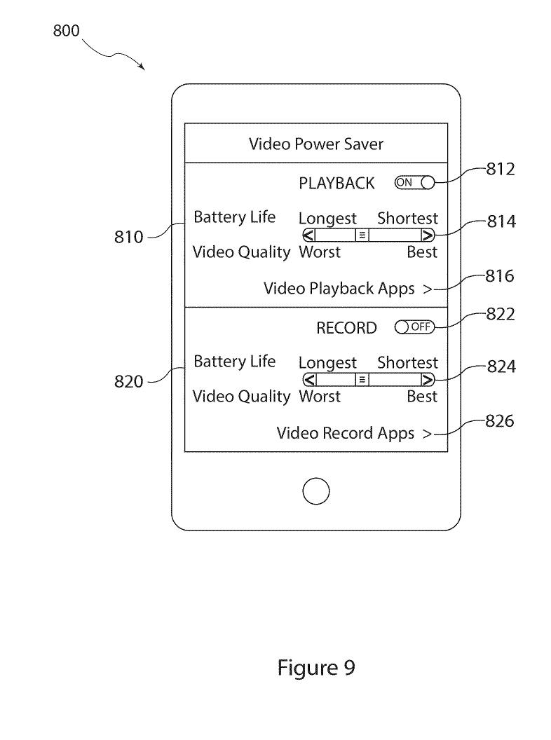

FIG. 9 illustrates a graphical user interface 800 implementing an example of the present invention's user control over the tradeoff between battery life and video quality during playback and recording for a mobile device. Graphical user interface 800 contains a playback control pane 810 and a record control pane 820. Within playback control pane 810, playback on/off selector 812 determines whether playback selection is enabled (ON) or disabled (OFF) for those video playback applications enabled by a playback application selector 816. Playback compression control slider element 814 determines the tradeoff between longest battery life (slider moved fully left) and best video quality (slider moved fully right) during video playback. Within the record control pane 820 the record on/off selector 822 determines whether record selection is enabled (ON) or disabled (OFF) for those video record applications enabled by a record app selection control 826. Record compression control slider element 824 determines the tradeoff between longest battery life (slider moved fully left) and best video quality (slider moved fully right) during video recording.

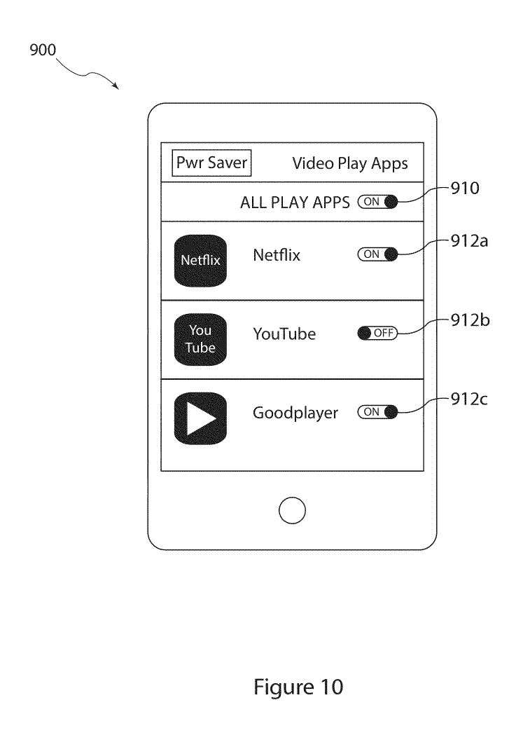

FIG. 10 illustrates a graphical user interface 900 implementing an example of the present invention's selection of which applications (“apps”) with video playback capabilities will observe the battery life/video quality selection described with respect to FIG. 9. In a preferred embodiment, graphical user interface 900 is displayed after the user selects or presses selector 816 in playback control plane 810. In FIG. 10, three example video playback applications (Netflix, YouTube, and Goodplayer) are shown, each with application-specific on/off control modules 912a, 912b, and 912c, respectively. In the “OFF” (disabled) position, the respective video playback application will ignore the battery life/video playback quality slider setting 814. In the “ON” (enabled) position, the respective video playback application will apply the battery life/video quality slider setting 814. An overall on/off selector 910 allows a user to apply battery life/video quality slider setting 814 to all applications having video playback capabilities.

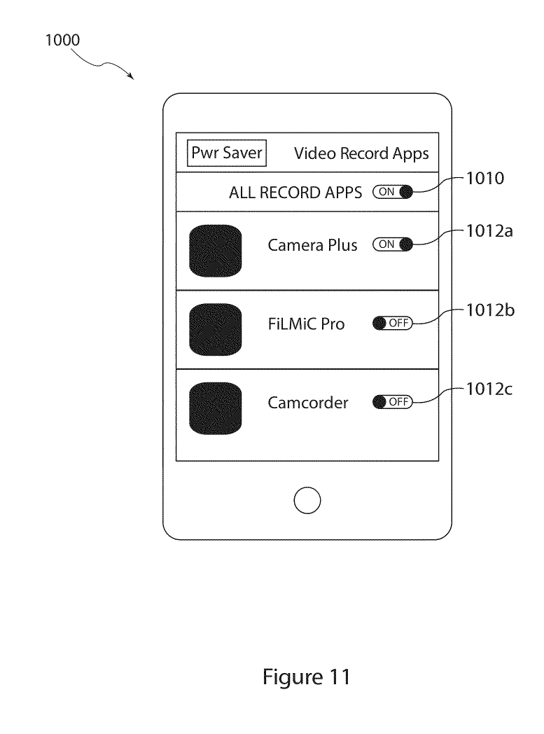

FIG. 11 illustrates a graphical user interface 1000 implementing an example of the present invention's selection of which applications (“apps”) with video record capabilities will observe the battery life/video quality selection described with respect to FIG. 9. In a preferred embodiment, graphical user interface 1000 is displayed after the user selects or presses selector 826 in record control plane 820. In FIG. 11, three example video record applications (Camera Plus, FiLMiC Pro, and Camcorder) are shown, each with application-specific on/off control modules 1012a, 1012b, and 1012c, respectively. In the “OFF” (disabled) position, the respective video record application will ignore the battery life/video record quality slider setting 824. In the “ON” (enabled) position, the respective video record application will apply the battery life/video record quality slider setting 824. An overall on/off selector 1010 allows a user to apply battery life/video record quality slider setting 824 to all applications having video record capabilities.

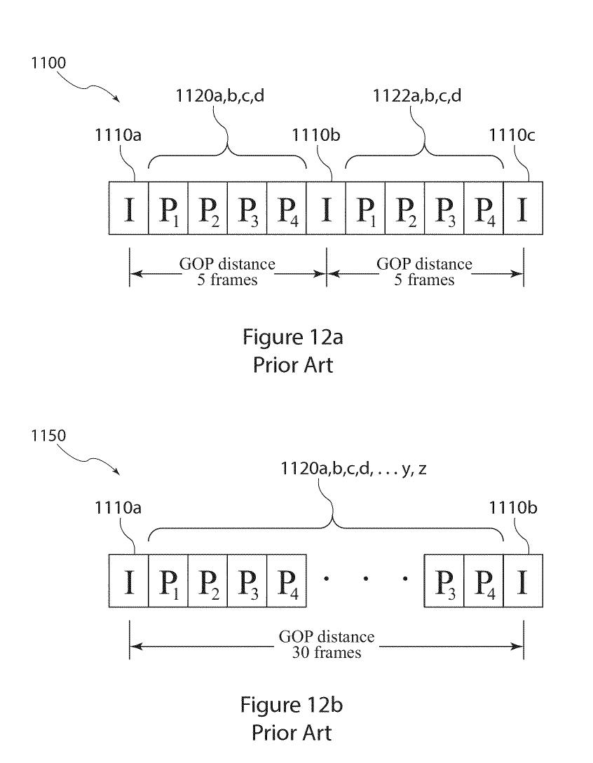

FIGS. 12a and 12b illustrate two examples of prior art Group of Pictures (GOP) distances. Prior art video compression algorithms compress certain video frames using only those pixels in the current frame; such frames are called I-frames. Prior art video compression algorithms also compress and decompress MacBlks in the current frame using MacBlks from previously decoded frames. Such decoded frames are called P-frames (“predicted” frames). FIG. 11a illustrates an example video encoder where the GOP distance is 5 frames, meaning that every sixth frame contains an I-frame. In FIG. 12a, elements 1110a, 1110b, and 1110c are I-frames, while elements 1120a, b, c, d and 1122a, b, c, d are P-frames. Similarly, FIG. 12b illustrates an example video encoder setting where GOP distance is 30 frames, where P-frames 1120a, b, c, . . . y,z are surrounded by I-frames 1110a and 1110b.

When the present invention encodes reference frames using a lossless encoding mode, the reference frames stored and retrieved during the MC stage of video decoding are identical to those stored and retrieved during the ME stage of video encoding, as previously discussed with respect to FIGS. 8a and 8b. When the present invention encodes reference frames using fixed-rate or fixed-quality encoding, the reference frames stored and retrieved during the MC stage of video decoding are similar, but are NOT identical, to those stored and retrieved during the ME stage of video encoding. This slight difference in the reference frames stored and retrieved during MC stage of video decoding may cause a “drift” between ME reference frames in the video encoder and ME reference frames in the video decoder. This “drift” is typically reset with each I-frame, since I-frames do not reference pixels or MacBlks in any other frame. The compression ratio of I-frames is typically less than the compression ratio of P-frames, so it is preferable to make the GOP distance as large as possible in order to maximize the compression ratio of the compressed video stream. On the other hand, if the channel between the transmitter (which sends the compressed video stream) and the receiver (which receives and displays the compressed video stream) experiences adverse conditions, both compressed I-frames and compressed P-frames may be lost or unusable. For this reason, the maximum GOP distance typically does not exceed the number of video frames sent in 1 second, so that when channel anomalies occur, the user will not experience more than a 1-second video drop-out.

The present invention takes advantage of the fact that degree of “drift” caused by fixed-rate and/or fixed-quality encoding of reference frames can be controlled by the present invention's fixed-rate and fixed-quality parameter settings. And since reference frame processing during ME and MC accounts for a significant percentage of mobile device power consumption during video playback and recording, adjusting the video quality parameter setting has a direct effect on power consumption, and thus on battery life.

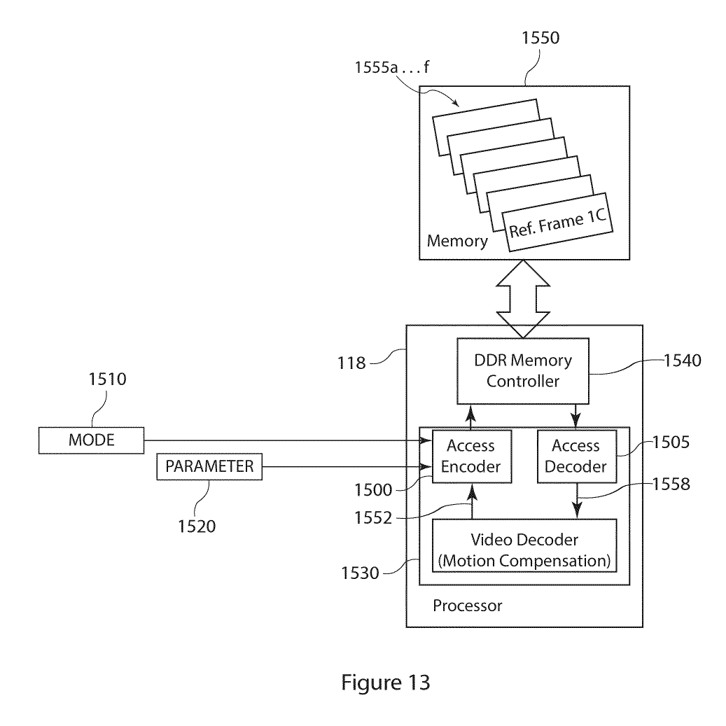

FIG. 13 illustrates how an access encoder's mode and parameter settings implement a flexible “battery life vs. video quality” selection by a user, or by control software. Access encoder 1500 and access decoder 1505 provide the MacBlk, raster, and/or reference frame encoding and decoding function, under the control of a compression mode selection 1510 and a compression parameter 1520 provided to access encoder 1500. Choices for compression mode selection 1510 include lossless, fixed rate, fixed quality, or a hybrid of fixed rate and fixed quality. For fixed-rate, fixed-quality, or hybrid mode selections, the compression parameter 1520 specifies the appropriate target parameter, such as the target compression ratio (such as 1.75:1 or 4:1), or the target quality (such as 40.2 dB PSNR, 35.5 dB SNR, 0.99999 Pearson's Correlation Coefficient, or 0.999 SSIM value). For hybrid mode, multiple compression parameter(s) 1520 may be used. In the example of FIG. 12, video decoder 1530 sends input reference frames 1552 to memory 1550 via access encoder 1500 and memory controller 1540. Similarly, video decoder 1530 receives decoded reference frames 1558 from memory 1550 via memory controller 1540 and access decoder 1505. When access encoder 1500 operates in lossless mode, as specified by compression mode selection 1510, decoded reference frames 1558 are identical to input reference frames 1552. When access encoder 1500 operates in fixed-rate or fixed-quality mode, as specified by compression mode selection 1510 and compression parameter 150, decoded reference frames 1558 are similar to, but not identical to, input reference frames 1552. In their encoded form, reference frames (or MacBlk or raster regions of such reference frames) are stored in memory 1550 as encoded MacBlks, rasters, or reference frames 1555. The example of FIG. 13 illustrates six encoded reference frames 1555a, 1555b, 1555c, 1555d, 1555e, and 1555f, where encoded reference frame 1555a precedes encoded reference frame 1555b, which precedes encoded reference frame 1555c, and so forth. When compression mode selection 1510 and compression parameter 1520 are coupled to FIG. 9's playback control slider 814 and/or record control slider 824, users of graphical user interface 800 are able to control the size of encoded reference frames 1555, which is proportional to power consumption of the mobile device. The higher the compression ratio, or the lower the specified video quality, the larger the battery life savings will be.

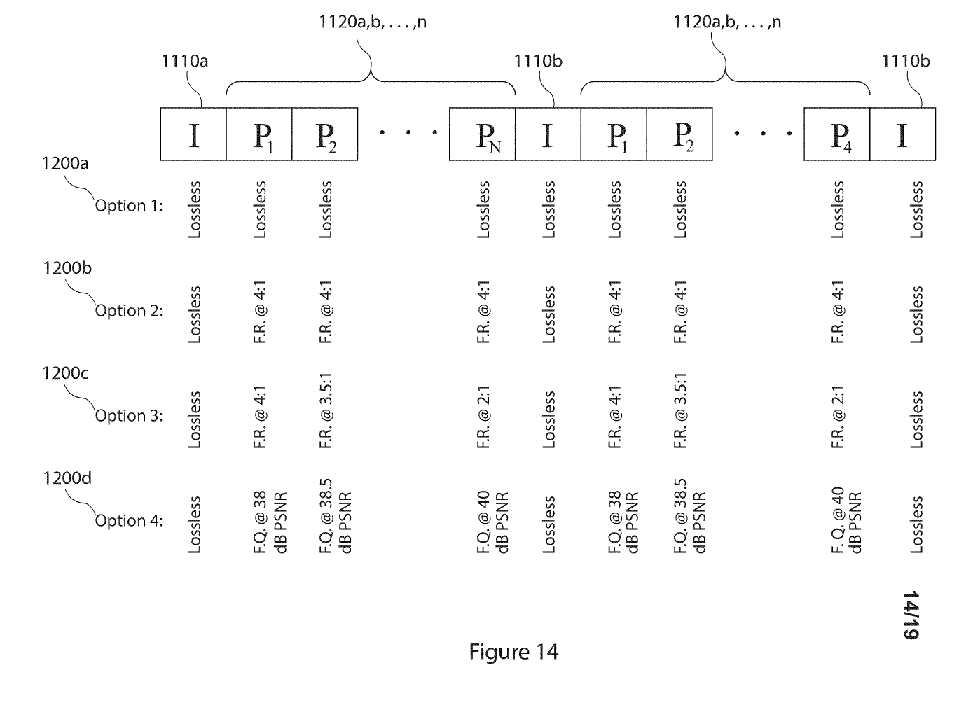

FIG. 14 illustrates one embodiment of the present invention, with multiple options, in which an access encoder's mode and parameter(s) may differ for I-frames and P-frames. In FIG. 14, Option 1 illustrates example mode and parameter settings 1200a, where compression mode 1510 FIG. 13 is “lossless” for both I-frames and P-frames. This setting will provide users with decoded video whose decoded reference frames 1558 are identical to the input reference frames 1552. In lossless mode, compression ratios between 1.5:1 and 3:1 can typically be expected, although the lossless compression ratio achieved on reference frames will vary, depending on the compressibility of the reference frames.

Option 2 illustrates example mode and parameter settings 1200b, where compression mode 1510 FIG. 13 is “lossless” for I-frames and fixed-rate at 4:1 compression ratio for P-frames. This setting will provide users with decoded I-frame reference frames 1558 that are identical to the corresponding I-frame input reference frames 1552. For P-frames, encoded reference frames will be encoded to occupy 4x less capacity in memory 1550, and decoded P-frame reference frames will be similar to, but not identical to, the corresponding P-frame input reference frames 1552. Option 2's battery savings will be larger than Option 1's battery savings, because the encoded reference frames 1555 will be smaller using Option 2's settings than Option 1's settings.

Option 3 illustrates example mode and parameter settings 1200c, where compression mode 1510 is “lossless” for I-frames and varies from fixed-rate at 4:1 compression ratio for the first P-frame, down to 2:1 compression ratio for the final P-frame. Option 3 will deliver less overall compression (and thus less battery life savings) than Option 2, but will result in better video quality because the compression ratio for later P-frames is lower that the quality for earlier P-frames (i.e. the video quality for later P-frames is better than the quality for earlier P-frames). Option 3 illustrates the present invention's capability to modify the target compression ratio of successive P-frames, in order to achieve better video quality, but lower battery life savings. As in Options 1 and 2, I-frames are losslessly compressed.

Option 4 illustrates example mode and parameter settings 1200d, where compression mode 1510 is “lossless” for I-frames and target video quality varies from 38 dB PSNR for the first P-frame, to 40 dB PSNR for the final P-frame (before the next I-frame). Option 4 illustrates the present invention's capability to modify the target reference frame image quality of successive P-frames, in order to achieve better video quality but lower battery life savings.

In summary, FIG. 14 has illustrated four options for modifying the settings of the present invention's compression mode 1510 and compression parameter 1520, in a way that flexibly enabled video quality tradeoffs that influence battery life. At higher compression ratio settings (lower video quality settings), battery life is increased. At lower compression ratio settings (higher video quality settings), battery life is decreased.

While the compression mode 1510 and compression parameter 1520 values shown in FIG. 13 were constant for all MacBlks in each reference frame of a GOP, FIG. 14 illustrates how the present invention's compression mode 1510 and compression parameter 1520 can be varied within each reference frame (i.e. can be varied from MacBlk to MacBlk, or raster to raster, within a reference frame), in order to trade off video quality for battery life.

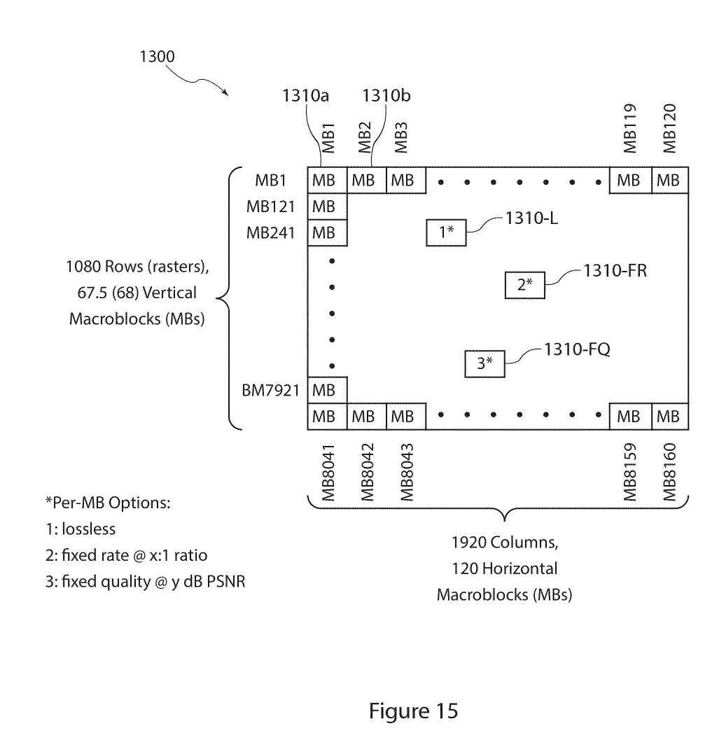

FIG. 15 illustrates the same 8160 MacBlks that were previously shown with respect to FIG. 2. Example MacBlk 1310-L is encoded using lossless mode, while Example MacBlk 1310-FR is encoded using a fixed-rate mode and MacBlk 1310-FQ is encoded using a fixed-quality mode. The selection of the appropriate compression mode 1510 and compression parameter 1520 for MacBlks 1310-FR and 1310-FQ can be determined through a variety of mechanism. For instance, the color components of each MacBlk can be monitored, and those having lower variance (which may indicate a more compressible MacBlk) can be assigned a higher fixed-rate compression parameter 1520, or a lower fixed-quality compression parameter 1520. Conversely, MacBlks with “busier” image content, possibly indicated by a higher variance in color components (which may indicate a less compressible MacBlk) can be assigned a lower fixed-rate compression parameter 1520, or a higher fixed-quality compression parameter 1520. A second embodiment might determine the lossless compression ratio of each MacBlk during a first pass then use the compressibility of each MacBlk to choose an appropriate fixed-rate or fixed-quality setting that is based on each MacBlk's lossless compression ratio. A third embodiment that determines compression mode 1510 and compression parameter 1520 will now be described.

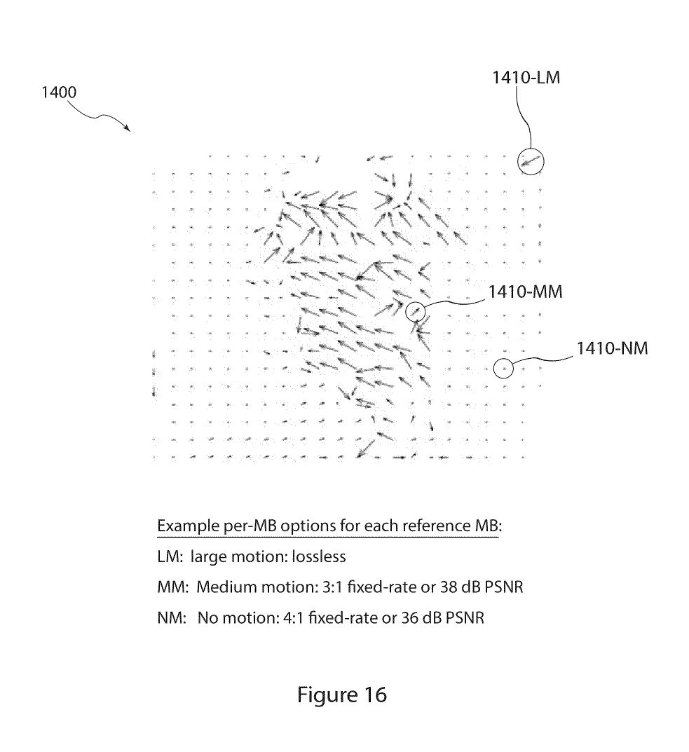

FIG. 16 illustrates an example of motion vectors determined during H.264 ME processing. The magnitude of each vector indicates the distance from the present MacBlk to the reference MacBlk, while the direction of each vector indicates the direction where that MacBlk's reference MacBlk is located. FIG. 16 illustrates that some MacBlk motion vectors, such as motion vector 1410-NM (“no motion”), are nearly zero, indicating that their corresponding reference frame is at the identical location in a previous frame. In contrast, other MacBlk motion vectors, such as motion vector 1410-LM (“large motion”), have large magnitude, indicating that their corresponding reference frame is quite a distance away in a previous reference frame. Finally, some MacBlk motion vectors, such as motion vector 1410-MM (“medium motion”), have magnitudes that are larger than zero, but smaller than those of motion vector 1410-LM, indicating that their corresponding reference frame is a moderate distance away in a previous reference frame.

FIG. 16 indicates a third embodiment of the compression mode and compression parameter selection techniques previously described with respect to FIG. 15. For all MacBlks in reference frames, it is possible to calculate each MacBlk's “reference count,” i.e. how many future MacBlks use the current MacBlk (or a portion thereof) as a reference. If some MacBlks are never used as reference frames by future MacBlks, they could be more highly compressed, because doing so will not affect future MacBlks. In contrast, MacBlks having a high reference count may be less aggressively compressed, since such MacBlks may be referred to by multiple, future MacBlks. Thus by increasing the decoded quality (decreasing the compression ratio) of MacBlks having a high “reference count,” overall image quality will be improved. Similarly, by decreasing the decoded quality (increasing the compression ratio) of MacBlks having a low (or zero) “reference count,” overall image quality will be unaffected while increasing battery life.

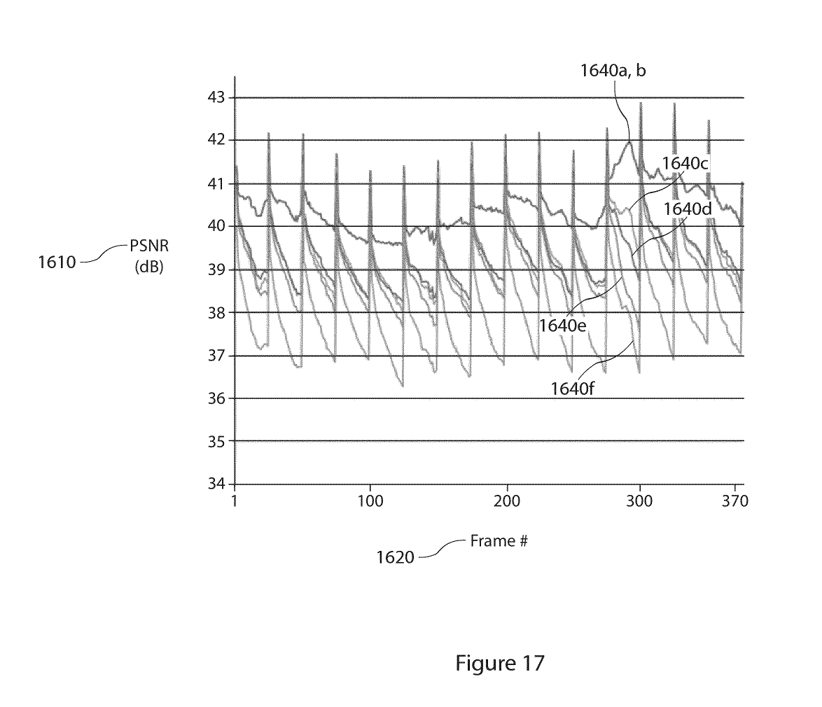

FIG. 17 illustrates how reference frame quality, as measured by PSNR parameter 1610, varies from frame to frame on x-axis frame number 1620, given different video quality targets or different compression ratio targets. Compression results 1640a through 1640f summarize five example {compression ratio, PSNR image quality} pairs. With higher compression ratios (lower PSNR), battery life is increased. With lower compression ratios (higher PSNR), battery life is decreased. The frame-by-frame PSNR value for the five settings are shown in FIG. 17 using graphs 1640a (frame-by-frame PSNR, without any reference frame encoding), 1640b (frame-by-frame PSNR, using lossless compression mode), 1640c (average of 5.04:1 compression ratio at PSNR=39.4 dB), 1640d (average of 5.97:1 compression ratio at PSNR=39.3 dB), 1640e (average of 6.49:1 compression ratio at PSNR=39.0 dB), and 1640f (average of 7.52:1 compression ratio at PSNR=37.9 dB). In summary, FIG. 17 illustrates five different tradeoffs between video quality (as measured by PSNR) and battery life (as measured by compression ratio).

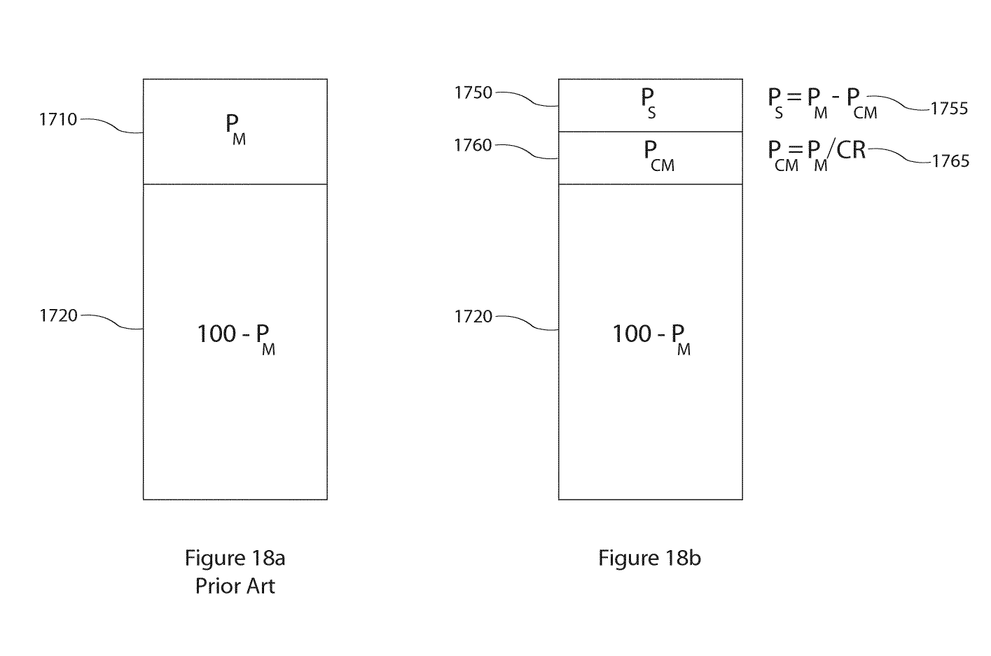

FIG. 18a illustrates a two-segment bar graph of the power consumption of an example mobile device, consisting of a memory power consumption (P_{M}) percentage 1710 and a non-memory power consumption percentage 1720. Since there are only two power consumption components illustrated in FIG. 18a, non-memory power consumption percentage 1720 equals 100 minus the memory power consumption P_{M} percentage 1720. FIG. 18b illustrates how mobile device power consumption for this example changes as the present invention allows users to trade off longer battery life (lower power consumption) during video playback and recording, with video quality. In FIG. 18b, compressed memory power consumption (P_{CM}) 1760 represents the percentage of total mobile memory power consumption when the present invention reduces memory power consumption by compressing video reference frames. The resulting memory power savings (PS) 1750 represents the percentage of total mobile power consumption that is realized using the present invention. Compressed memory power equation 1765 illustrates that the original memory power consumption percentage 1710 is reduced to P_{CM}/CR when the present invention's reference frame compression is enabled. Similarly, compressed memory power savings equation 1755 illustrates how to calculate the power savings due to reference frame compression when the present invention's reference frame compression is enabled. Given equations 1755 and 1765, it is apparent that P_{S} is increased (additional power savings) as CR is decreased, and that P_{S} is decreased (less power savings) as CR is increased.

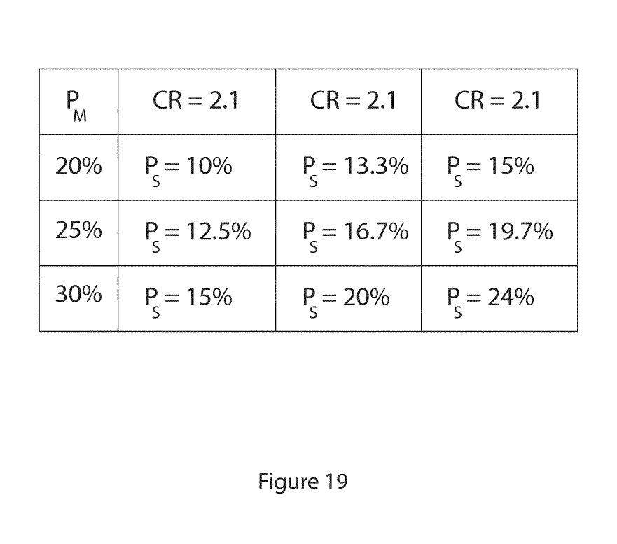

FIG. 19 provides nine examples of how power savings P_{S} 1750 changes with three examples of P_{M} values and three example compression ratios (CR). The three values PM (in the left-most column of the table in FIG. 19) and the nine values of PS (in the three columns on the right of the table in FIG. 19) are calculated using equations 1755 and 1765. For example, when PM=20% (20% of mobile device power consumption is due to memory power from video playback and/or recording), compression ratios of 2:1, 3:1, and 4:1 result in a power savings of 10%, 13.3%, and 15% respectively. When PM=20% compression ratios of 2:1, 3:1, and 4:1 result in a power savings of 12.5%, 16.7%, and 19.7% respectively. When PM=30% compression ratios of 2:1, 3:1, and 4:1 result in a power savings of 15%, 20%, and 24% respectively.

As illustrated using FIGS. 18 and 19, mobile power consumption savings 1750 can be calculated using memory power consumption (P_{M}) percentage 1710 and compression ratio CR. Memory power consumption percentage 1710 can be measured using common, prior art techniques, such as monitoring voltage and current draw before and after video playback (or video recording, or both) are enabled. Compression ratio CR is a control parameter that in turn determines the power savings PS enabled by the present invention's reference frame compression, and controlled by the present invention's user control, such as video playback power control slider 814 and video record power control slider 824. Remaining battery life (typically measured in Watt-hours) can be calculated given power consumption and battery capacity measurements, while video quality can be measured using a variety of existing image and/or video quality metrics, including peak signal-to-noise ratio (PSNR), signal-to-noise ratio (SNR), and structural similarity (SSIM). Thus all of the parameters required to calculate the battery life and video quality metrics that surround video playback control slider 814 and video record control slider 824 are available to mobile devices.

A variety of implementation alternatives exist for the embodiments of the present invention's access encoder controllers, such as implementation in a microprocessor, graphics processor, digital signal processor, field-programmable gate array (FPGA), application-specific integrated circuit (ASIC), or system-on-chip (SoC). The implementations can include logic to perform the functions and/or processes described herein, where the logic can include dedicated logic circuits, configurable logic such as field programmable logic array FPGA blocks, configured to perform the functions, general purpose processors or digital signal processors that are programmed to perform the functions, and various combinations thereof.

The access encoder's operations can be implemented in hardware, software or a combination of both, and incorporated in computing systems. The hardware implementations include ASIC, FPGA or an intellectual property (IP) block for a SoC. The access encoder's operations can be implemented in software or firmware on a programmable processor, such as a digital signal processor (DSP), microprocessor, microcontroller, multi-core CPU, or GPU.

In one embodiment implemented in a programmable processor, programs including instructions for operations of the access encoder are provided in a library accessible to the processor. The library is accessed by a compiler, which links the application programs to the components of the library selected by the programmer. Access to the library by a compiler can be accomplished using a header file (for example, a file having a “.h” file name extension) that specifies the parameters for the library functions and corresponding library file (for example, a file having a “.lib” file name extension, a “.obj” file name extension for a Windows operating system, or a file having a “.so” file name extension for a Linux operating system) that use the parameters and implement the operations for the access encoder. The components linked by the compiler to applications to be run by the computer are stored, possibly as compiled object code, for execution as called by the application. In other embodiments, the library can include components that can be dynamically linked to applications, and such dynamically linkable components are stored in the computer system memory, possibly as compiled object code, for execution as called by the application. The linked or dynamically linkable components may comprise part of an application programming interface (API) that may include parameters for compression operations.

For implementation using FPGA circuits, the technology described here can include a memory storing a machine readable specification of logic that implements the access encoder, and a machine-readable specification of the access decoder logic, in the form of a configuration file for the FPGA block. For the system shown in FIG. 1, optionally including additional components, the access encoder may be described using computer aided design tools and expressed (or represented), as data and/or instructions embodied in various computer-readable media, in terms of their behavioral, register transfer, logic component, transistor, layout geometry, and/or other characteristics. A machine readable specification of logic that implements the access encoder and a machine-readable specification of the access encoder's functions can be implemented in the form of such behavioral, register transfer, logic component, transistor, layout geometry and/or other characteristics. Formats of files and other objects in which such circuit expressions may be implemented include, but are not limited to, formats supporting behavioral languages such as C, Verilog, and VHDL, formats supporting register level description languages like RTL, and formats supporting geometry description languages such as GDSII, GDSIII, GDSIV, CIF, MEBES and any other suitable formats and languages. A memory including computer-readable media in which such formatted data and/or instructions may be embodied include, but are not limited to, computer storage media in various forms (e.g., optical, magnetic or semiconductor storage media, whether independently distributed in that manner, or stored “in situ” in an operating system).

When received within a computer system via one or more computer-readable media, such data and/or instruction-based expressions of the above described circuits may be processed by a processing entity (e.g., one or more processors) within the computer system in conjunction with execution of one or more other computer programs including, without limitation, netlist generation programs, place and route programs and the like, to generate a representation or image of a physical manifestation of such circuits. Such representation or image may thereafter be used in device fabrication, for example, by enabling generation of one or more masks that are used to form various components of the circuits in a device fabrication process.

While the preferred embodiments of the invention have been illustrated and described, it will be clear that the invention is not limited to these embodiments only. Numerous modifications, changes, variations, substitutions and equivalents will be apparent to those skilled in the art, without departing from the spirit and scope of the invention, as described in the claims.

What is claimed is:

1. A video system comprising:
a. an on/off selector;
b. a video application selector; and
c. a compression control module which controls reference frame compression in an access encoder, wherein:
i. as a compression ratio increases power consumption of the device decreases; and,
ii. as the compression ratio decreases, power consumption of the device increases.

2. The video system of claim 1, further comprising:
a. A decompression control module which controls reference frame decompression in an access decoder.

3. The video system of claim 1, wherein the compression control module controls compression by setting an attenuator parameter to an attenuator module located in the access encoder.

4. The video system of claim 2, wherein the compression control module controls decompression by sending the attenuation parameter to a gain module located in the access decoder.

5. The video system of claim 1, wherein the on/off selector further comprises:
a. a video playback selector; and,
b. a video record selector.

6. The video system of claim 1, wherein the video application selector further comprises:
a. a video playback applications selector; and,
b. a video record application selector.

7. The video system of claim 3, wherein the video play applications selector further comprises:
a. a plurality of application selectors.

8. The video system of claim 3, wherein the video record applications selector further comprises:
a. a plurality of application selectors.

9. The video system of claim 1, wherein the device is a mobile, battery-powered device.

10. The video system of claim 1, wherein the compression control module is comprised of a slider, knob, or fader.

11. The video system of claim 1, wherein reference frame compression is performed in an access encoder during motion estimation.

12. The video system of claim 1, wherein reference frame compression is performed in an access encoder during motion compensation.

13. The video system of claim 1, wherein reference frame compression includes a lossless mode, a fixed-rate mode, and a fixed-quality mode.

14. The video system of claim 11, wherein the compression control module ensures that the reference frame compression is the same for each macroblock in a reference frame.

15. The video system of claim 11, wherein the compression control module selects from lossless, fixed-rate, or fixed-quality modes for each macroblock of a reference frame.

16. The video system of claim 1, wherein control and selections elements are implemented as a control application having a graphical user interface that a user accesses to control the tradeoff between device battery life and device video quality.

17. An application processor comprising:
a. an on/off selector;
b. a video application selector; and
c. a compression control module which controls reference frame compression in an access encoder, wherein:
i. as a compression ratio increases power consumption of the device decreases; and,
ii. as the compression ratio decreases, power consumption of the device increases.

18. The application processor of claim 17, further comprising:
a. A decompression control module which controls reference frame decompression in an access decoder.

19. A method for controlling compression in a video system, comprising the steps of:
a. activating a video application selector;
b. selecting a video application; and,
c. adjusting a compression control module input which controls compression in an access encoder.

20. The method of claim 17, wherein the step of adjusting the compression control module input further comprises controlling decompression in an access decoder.

21. The method of claim 18, wherein the steps of activating, selecting, and adjusting comprise manipulating a switch.

22. The method of claim 18, wherein the step of adjusting a compression control module comprises manipulating a slider, knob, or fader.

23. The method of claim 18, wherein the steps of activating, selecting, and adjusting comprise providing inputs to a graphical user interface controlled by a control application.
